(19) United States
(12) Patent Application Publication
(10) Pub. No.: US 2025/0252269 A1
(43) Pub. Date: Aug. 7, 2025

(54) SYSTEM AND METHOD FOR CONGREGATING LEARNING AND DEVELOPMENT INFRASTRUCTURES

(71) Applicant: Ebony Coburn, Camarillo, CA (US)

(72) Inventor: Ebony Coburn, Camarillo, CA (US)

(21) Appl. No.: 18/430,363

(22) Filed: Feb. 1, 2024

(51) Int. Cl. G06F 40/40; G06Q 10/0631; G06Q 10/1053; G06T 13/40; H04L 67/306

(52) U.S. Cl. CPC G06F 40/40; G06Q 10/06315; G06Q 10/1053; G06T 13/40; H04L 67/306

(57) ABSTRACT

In an approach for monitoring and tracking professional development activities to empower end-users to obtain better employment opportunities, based on networking with those within the field and receiving training based on job related skills associated with various professions. A processor receives user information to create a user profile, wherein the user information includes natural language input. A processor creates the user profile for a user, wherein the user profile is based on the user information. A processor generates a dynamic story using artificial intelligence, wherein the dynamic story is based on the user information. A processor displays the dynamic story.

### CROSS REFERENCE TO RELATED APPLICATIONS

The present application claims the benefit of U.S. Provisional Application No. 63/488,744, filed Mar. 6, 2023, which is hereby incorporated by reference in its entirety.

### BACKGROUND

The present invention relates generally to the field of professional development and career growth, and more particularly to monitoring and tracking professional development activities to empower end-users to obtain better employment opportunities, based on networking with those within the field and receiving training based on job related skills associated with various professions.

Modern professional development networks use a variety of tools to help guide users' professional careers. These tools include social networking, assessment tests, resume help, online courses, and certifications, etc.

### SUMMARY

Aspects of an embodiment of the present invention disclose a method, computer program product, and computing system for monitoring and tracking professional development activities to empower end-users to obtain better employment opportunities, based on networking with those within the field and receiving training based on job related skills associated with various professions. A processor receives user information to create a user profile, wherein the user information includes natural language input. A processor creates the user profile for a user, wherein the user profile is based on the user information. A processor generates a dynamic story using artificial intelligence, wherein the dynamic story is based on the user information. A processor displays the dynamic story.

The foregoing summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE DRAWINGS

FIG. 1 depicts a block diagram of a computing system, in accordance with an embodiment of the present invention.

FIG. 2 depicts a flowchart of the steps of a generation program, executing within the computing system of FIG. 1, for monitoring and tracking professional development activities to empower end-users to obtain better employment opportunities, based on networking with those within the field and receiving training based on job related skills associated with various professions.

FIG. 3 depicts a block diagram of components of the server and/or the computing devices of FIG. 1, in accordance with an embodiment of the present invention.

### DETAILED DESCRIPTION

It is known that colleges & universities, businesses, and other entities will provide professional development opportunities and training for their students and employees. Systems, methods, apparatuses, infrastructures, algorithms, and computer program products are disclosed herein for a professional development and career growth platform that will be more effective in leveraging the capabilities and skills of the user, through a variety of methods.

An example system and method for congregating computer gaming, learning, and professional development infrastructures is disclosed herein. The example system and method includes creating a career and professional development learning environment that is game based in both look and feel, that is developed using a modern game engine such as Unreal, that incorporates the creation and use of a dynamic digital human capable of learning and evolving alongside the user, and a proprietary algorithm, that allows for the creation of machine learning models capable of accounting for the lived experience of the user when developing the user's profile. The example system and method further include game-based elements and mechanics for how a user's profile is developed, how a user's lived experience is measured, how learning experiences correlate with earning experience points (XP), and character profile levels, that result in badges and other achievements. The example system and method also include game-based mechanics and protocols that include strategy guides, personalized walkthroughs, and goal setting that will behave like a role-playing game.

Embodiments of the present invention recognize that several market sectors may have an interest in data for specific interactions that their customer base has outside of their platform. Embodiments of the present invention recognize that entities such as educational institutions, businesses, recruiters, and workforce employment centers may need specific user data to better understand and serve their client base. Artificial intelligence (AI), in combination with machine learning (ML), is oftentimes used by most of these entities to address this issue, as well as provide improved solutions for them. However, embodiments of the present invention recognize that consumers participate and engage on multiple platforms and this data is not available to businesses because various interactions happened outside of their platform, limiting the businesses' ability to have more accurate representations of their client base.

Embodiments of the present invention improves the system and method by which artificial intelligence can be used to capture user data by using digital humans capable of leaving the platform of origin and traveling to other platforms. Embodiments of the present invention recognize that, while in transit, the digital human will be able to collect and store data that is learned from the outside platform and bring the information back to the platform of origin. For example, the user takes their digital human off the platform and uses it in another space, such as a virtual conference, video game, or the metaverse. The digital human is collecting data from those experiences so that when the user comes back to the platform the data is broken down and analyzed to show the new learning that was obtained, how it evolves the user and the digital human, and how the new learning experiences changes and/or shows new opportunities in the user's journey for professional growth and career advancement.

Embodiments of the present invention disclose an approach to monitor and track professional development activities to empower end-users to obtain better employment opportunities, based on networking with those within the field and receiving training based on job related skills associated with various professions.

Embodiments of the present invention will now be described in detail with reference to the Figures.

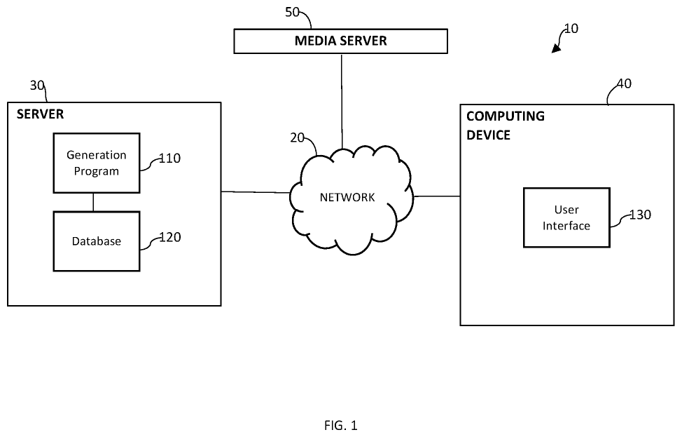

FIG. 1 depicts a block diagram of computing system 10, in accordance with one embodiment of the present invention. FIG. 1 provides an illustration of one embodiment and does not imply any limitations with regard to the environments in which different embodiments may be implemented.

In the depicted embodiment, computing system 10 includes server 30, computing device 40, and media server 50 interconnected over network 20. Network 20 may be a local area network (LAN), a wide area network (WAN) such as the Internet, a cellular data network, any combination thereof, or any combination of connections and protocols that will support communications between server 30, computing device 40, and media server 50, in accordance with embodiments of the invention. Network 20 may include wired, wireless, or fiber optic connections. Computing system 10 may include additional computing devices, servers, or other devices not shown.

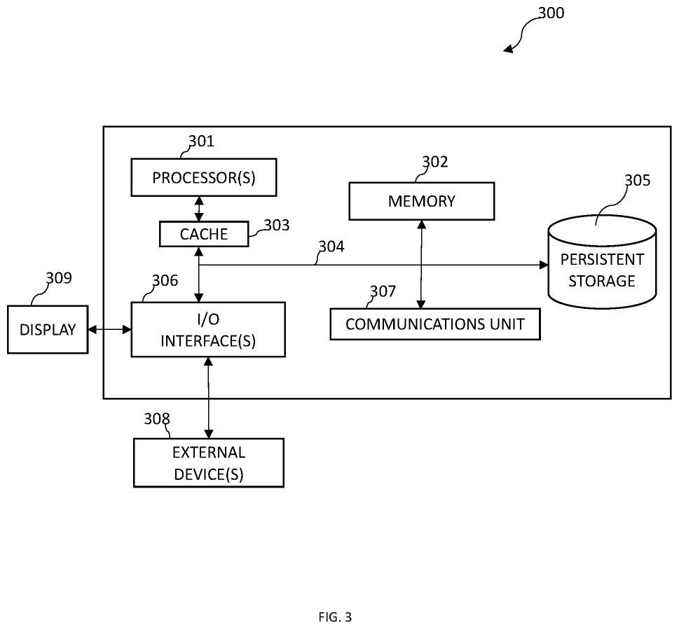

Server 30 may be a management server, a web server, or any other electronic device or computing system capable of processing program instructions and receiving and sending data. In some embodiments, server 30 may be a laptop computer, tablet computer, netbook computer, personal computer (PC), a desktop computer, or any programmable electronic device capable of communicating with computing device 40 via network 20. In other embodiments, server 30 may represent a server computing system utilizing multiple computers as a server system, such as in a cloud computing environment. In another embodiment, server 30 represents a computing system utilizing clustered computers and components to act as a single pool of seamless resources. In the depicted embodiment, server 30 contains generation program 110 and database 120. In other embodiments, server 30 may include generation program 110, database 120, and/or other components, as depicted and described in further detail with respect to FIG. 3.

Computing device 40 may be a personal device, desktop computer, laptop computer, netbook computer, tablet computer, management server, web server, or application server. In general, computing device 40 may be any electronic device or computing system capable of processing program instructions, sending and receiving data, and communicating with other devices over a network. In the depicted embodiment, computing device 40 contains user interface 130. In other embodiments, computing device 40 may include user interface 130 and/or other components, as depicted and described in further detail with respect to FIG. 3.

Media server 50 may be a management server, a web server, or any other electronic device or computing system capable of processing program instructions and receiving and sending data. In some embodiments, media server 50 may be a laptop computer, tablet computer, netbook computer, personal computer (PC), a desktop computer, or any programmable electronic device capable of communicating with server 30 and computing device 40 via network 20. In other embodiments, media sever 50 may represent a server computing system utilizing multiple computers as a server system, such as in a cloud computing environment. In another embodiment, media sever 50 represents a computing system utilizing clustered computers and components to act as a single pool of seamless resources. In one embodiment, media server 50 contains information, such as, for example, expressions of interest from various social media websites. In some embodiments, media server 50 is any online platform that hosts educational, learning, entertainment, and/or job-related resources. In other embodiments, media server 50 hosts a social networking website. In some embodiments, media server 50 is a social media platform. In other embodiments, media server 50 may include multiple components, as depicted and described in further detail with respect to FIG. 3.

Generation program 110 monitors and tracks professional development activities to empower end-users to obtain better employment opportunities, based on networking with those within the field and receiving training based on job related skills associated with various professions. In doing so, generation program 110 receives user information to create a user profile. Generation program 110 creates the user profile. Generation program 110 generates a dynamic story. Generation program 110 delivers the dynamic story. In the depicted embodiment, generation program 110 resides on server 30. In other embodiments, generation program 110 may reside on another server, computing device 40, or another computing device, provided that generation program 110 can access database 120 and user interface 130.

Database 120 may be a repository that may be written to and/or read by generation program 110. In some embodiments, generation program 110 may map user information with metadata associated with the user and store the mapped user information with metadata associated with the user to database 120. In other embodiments, database 120 may store previously created user profiles. In the depicted embodiment, database 120 resides on server 30. In other embodiments, database 120 may reside on another server, computing device 40, or another computing device, provided that database 120 is accessible to generation program 110.

User interface 130 may be any user interface used to access information from server 30, such as information gathered or produced by generation program 110. In some embodiments, user interface 130 may be a generic web browser used to retrieve, present, and negotiate information resources from the Internet. In other embodiments, user interface 130 may be a software program or application that enables a user at computing device 40 to access server 30 over network 20. In the depicted embodiment, user interface 130 resides on computing device 40. In other embodiments, user interface 130 may reside on another computing device or another server, provided that user interface 130 is accessible to generation program 110.

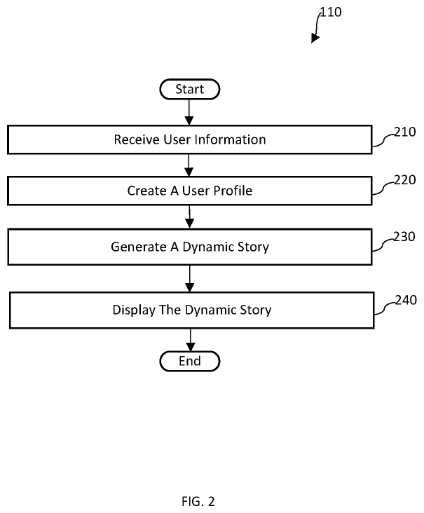

FIG. 2 depicts a flowchart of the steps of a generation program, executing within the computing system of FIG. 1, in accordance with an embodiment of the present invention. Generation program 110 monitors and tracks professional development activities to empower end-users to obtain better employment opportunities, based on networking with those within the field and receiving training based on job related skills associated with various professions.

In step 210, generation program 110 receives user information to create a user profile. In one embodiment, generation program 110 receives user information from a user through user interface 130. In some embodiments, generation program 110 receives user information from social media and professional development sites (e.g., Facebook, LinkedIn, Instagram, Discord, etc.), entertainment media (e.g., TV streaming services, video game accounts, etc.), and business and educational institutions that the user is affiliated with. In other embodiments, generation program 110 receives the user information through natural language input. In some embodiments, generation program 110 retrieves user information from media server 50. In other embodiments, generation program 110 stores the user information to database 120.

User information is any information that may be sent to generation program 110 to be used to create a user profile or that generation program 110 may retrieve to create a user profile. User information may include, but not limited to: pictures; answers to questions asked (e.g., about the user's childhood, parents, role models, influences, aspirations, accomplishments, failures, etc.); resumes; professional experiences (e.g., previous/current employment and associated information); educational experiences (e.g., schools, degrees, and certifications); lived experiences (e.g., hometown, cultural background, self-taught competencies, personal successes and failures, interests, etc.); and goals for the user's personalized experience on platform.

In some embodiments, before generation program 110 receives user information, generation program 110 determines if the user is new or if the user is returning. In one embodiment, the user connects to other social media profiles to automatically send user information to generation program 110. In other embodiments, before generation program 110 receives user information, the user is given the option to customize settings that pertain to language, accessibility, and the level of gamification to be added to the user's profile (e.g., little to no gamification, some gamification, and fully gamified). Gamification relates to digital badges, earning experience, leveling up, and unlocking digital assets and digital items. In some embodiments, a digital human guides the user through the registration process and explains the meaning of each step and why each step is important.

In step 220, generation program 110 creates the user profile. In one embodiment, generation program 110 analyzes all of the user information to determine how to best represent on the user's profile. In some embodiments, generation program 110 categorizes the user information into groups and assigns values, based on professional educational, and lived experience metrics. In one embodiment, generation program 110 assigns numerical values to educational experiences, personal and cultural experiences, and skills and qualifications associated with various professions. In some embodiments, generation program 110 creates a new metric system of lived experiences based on role-playing game (RPG) metrics. There are two categories: physical (e.g., strength, constitution, and dexterity) and mental (e.g., intelligence, wisdom, and charisma).

In other embodiments, generation program 110 creates a dynamic digital human to serve as the user's digital representation on this platform and other platforms where digital humans exist. A digital human is an avatar that can produce a whole range of human body language, backed by artificial intelligence that can interpret users' input and give back to them not just the facts they need but the appropriate non-verbal response as well.

The digital human will have the educational, professional, and lived experiences of the user imprinted/programmed into their AI model. The digital human will also contain information/programming from the software, as well, to help the user better understand their decisions, how their decisions impact them, and how to best move forward with their goals. The digital human will be able to take on the cultural and socioeconomic background and history of the user and will be able to learn the same characteristics from other users and other digital humans. Because the digital human can be made to look unique/fictional, real life-like physical appearance characteristics will not be apparent unless the user chooses to make a life-like representation of themselves. The user and the digital human are one in the same, as the digital human is a virtual representation of the user and is controlled by the user. Learning activities of any kind will generate an action or reaction from the digital human; if no learning activity is engaged, then the digital human waits for the user's input.

When the user completes a learning activity (e.g., take class, watch a video, read an article, interact with another user, or play a game), the experience will be recorded and analyzed, internally, to determine what skills/attributes were gained or strengthened because of it. As a result, the digital human will also gain the new knowledge. The digital human will be able to give the user new understanding and direction based on the new knowledge, as well as explain how to best utilize what they have gained. Thus, the digital human has evolved, and this evolution is sometimes beyond the growth of the user because the digital human will be able to take all previously stored data from outside data sources to better understand what the new knowledge means at a larger scale, as well as if there is any cultural significance to gained. The evolution and learning between digital human and user opens up new opportunities that are displayed directly on the user's profile.

In some embodiments, generation program 110 receives a picture from a user upload to assist in creating the user's digital human, which is used to make the digital human as closely matched to the user as possible, based on the picture provided. In other embodiments, if the user decides not to upload a picture, generation program 110 uses a character creation software tool to create the user's digital human, based on the assets the software has created. In some embodiments, generation program 110 uses a digital human to gain more user information about the user by asking questions for the user to answer, which is meant to capture the lived experiences of the user. In one embodiment, the user answers the questions by speaking directly to the digital human, having their audio recorded. In other embodiments, the user answers the questions by typing the answers. In some embodiments, generation program 110 uses built-in artificial intelligence, machine learning, algorithms, models, and data pools to analyze the received or retrieved user information to create unique user profiles and/or personalized digital humans for the user.

In one embodiment, generation program 110 gives the user the option to set one or more goals for the user's personalized experience on the platform. In doing so, the user may specify the following, but not limited to: if they are trying to get into college or get through college, if they are trying to transition into another career, or if they are completing some professional development training. In some embodiments, generation program 110 identifies a mentor or company for the user to cater their learning around. In other embodiments, generation program 110 receives information from the user about a mentor or company that they would like to cater their learning around. In one embodiment, the mentor and/or company will have their AI model or digital human that is pre-programed by the mentor, celebrity expert, industry expert, or company to provide specific information that one or more users want to learn or know more about. If the user asks a question that the mentor does not know, the AI will search all various sources (e.g., open educational resources, social media, compilation sites, public profiles, etc.) to supply that knowledge, as well make the “live mentor” or existing company aware of the lack of data so that the models can be updated to include the new knowledge. These models will be updated regularly to provide the most relevant information to the user.

The mentor, either a person or a company, will have their own AI model/digital human connected to the platform. The mentor/company AI model will be initially trained to answer questions in certain categories that have been predefined by the real-life person or company. If a question arises that does not fall within one of the predefined categories, but is a legitimate question, the information will be sent to an account manager who will validate the legitimacy of the question and then reach out to the company/person to request the information and provide an update to their AI model. The company/person will then speak or type to their digital human giving them the new, learned information and that new, learned information is then sent back to the user who originally requested the information.

In one embodiment, a dynamic user strategy guide is part of the user's profile. A strategy guide is a comprehensive manual that details and maps out the best strategies to accomplish a goal or a task. The strategy guide will detail how to study, train for, interview, and obtain a particular job or profession. In some embodiments, generation program 110 creates the strategy guide as part of the user's profile based on how the user obtained their current career and will dynamically update the strategy guide when more user information is received from the user.

The user will have the option of integrating mentor suggestions into their strategy guide with standard recommendations. There will be three layers of information in this integration of the dynamic strategy guide: the user's unique strategy guide, the user's chosen mentor's recommendations integrated, and industry standards for the chosen profession and/or career, so that other users who look to follow this guide has a complete understanding of all personal and professional recommendations that exist. The strategy guide will detail the following: overview, which explains how to use the guide and the various sections; walkthrough, which plots the most direct route to complete the user's defined goals; visual completion timeline, which gives a visual representation of the walkthrough along with a detailed timeline of how long it will take to complete each milestone; guided journey, which covers each learning activity, gaming simulation, and other activities available to the user in order to better prepare for the milestones ahead; methods & analysis, which details and explains each decision the user can make, the consequences behind those decisions, and how to best maximize their current skills and attributes; inventory, which lists the vanity items and other collectibles the user has earned; challenges, which list the known challenges that the user will face on their journey and how to best prepare for them; and extras, which lists the user's certifications, achievements, badges, unlockable items, etc.).

If the user decides not to choose a mentor to provide recommendations to the user strategy guide, then the standard guide with the user integrations will be generated. Also, the user can decide to choose a business or school in lieu of a mentor. The business or school would provide recommendations for the user to include in the user strategy guide. If this is selected by the user, the entity will be notified to build custom pathways for the user and the user will be able to directly connect their profile to that entity. If the user decides they want recommendations integrated but do not want their profile directly connected to the entity, the user can choose that option as well. This allows the user to keep their information private and the entities will not be notified of the user's progress.

In step 230, generation program 110 generates a dynamic story. In one embodiment, generation program 110 uses artificial intelligence to generate the dynamic story, based on the user information within the user's profile. In some embodiments, generation program 110 generates a dynamic story that tells the story of the user's life from start to current in an engaging and favorable way, highlighting the user's critical milestones.

In step 240, generation program 110 delivers the dynamic story. In one embodiment, generation program 110 delivers the dynamic story to the user in a video elevator pitch, created using the user's digital human that summarizes the user's story. In some embodiments, generation program 110 tailors the video elevator pitch to fit a job for which the user is applying. In other embodiments, generation program 110 formats the video elevator pitch using the user's digital human.

FIG. 3 depicts computer system 300, which is an example of a system that includes components of server 30 and/or computing device 40. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307. Generation program 110 and database 120 may be downloaded to persistent storage 305 of server 30 through communications unit 307 of server 30. User interface 130 may be downloaded to persistent storage 305 of computing device 40 through communications unit 307 of computing device 40.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., generation program 110 and database 120, can be stored on such portable computer readable storage media and can be loaded onto persistent storage 305 of server 30 via I/O interface(s) 306 of server 30. Software and data used to practice embodiments of the present invention, e.g., user interface 130, can be stored on such portable computer readable storage media and can be loaded onto persistent storage 305 of computing device 40 via I/O interface(s) 306 of computing device 40. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more processors, user information to create a user profile, wherein the user information includes natural language input;
creating, by one or more processors, the user profile for a user, wherein the user profile is based on the user information;
generating, by one or more processors, a dynamic story using artificial intelligence, wherein the dynamic story is based on the user information; and
displaying, by one or more processors, the dynamic story.

2. The method of claim 1, wherein the user information includes a picture, an answer to a question about a user, a resume, a professional experience, an educational experience, a lived experience, and a goal for the user.

3. The method of claim 1, further comprising:
analyzing, by one or more processors, the user information to determine how to represent on the user profile;
categorizing, by one or more processors, the user information into groups;
assigning, by one or more processors, numerical values to lived experiences, wherein the lived experiences include educational experiences, personal experiences, cultural experiences, and skills and qualifications associated with one or more professions; and
creating, by one or more processors, a metric system of the lived experiences, based on role-playing game metrics.

4. The method of claim 3, further comprising:
identifying, by one or more processors, the user information;
mapping, by one or more processors, the user information with metadata associated with the user; and
storing, by one or more processors, the mapping of the user information with the metadata associated with the user.

5. The method of claim 1, further comprising:
creating, by one or more processors, a dynamic digital human to serve as a digital representation of the user on one or more platforms, wherein the digital human is an avatar that produces human body language, backed by artificial intelligence that can interpret an input of the users and give facts back to the user and non-verbal responses.

6. The method of claim 1, further comprising:
creating, by one or more processors, a dynamic user strategy guide, wherein the dynamic user strategy guide is a comprehensive manual that details and maps out one or more strategies to accomplish a goal or a task and automatically updates when additional user information is received.

7. The method of claim 1, wherein the user information is received from a user through voice and converted to text for natural language processing purposes.

8. A computer program product comprising:
one or more computer readable storage media and program instructions stored on the one or more computer readable storage media, the program instructions comprising:
program instructions to receive user information to create a user profile, wherein the user information includes natural language input;
program instructions to create the user profile for a user, wherein the user profile is based on the user information;
program instructions to generate a dynamic story using artificial intelligence, wherein the dynamic story is based on the user information; and
program instructions to display the dynamic story.

9. The computer program product of claim 8, wherein the user information includes a picture, an answer to a question about a user, a resume, a professional experience, an educational experience, a lived experience, and a goal for the user.

10. The computer program product of claim 8, further comprising:
program instructions, stored on the one or more computer readable storage media, to analyze the user information to determine how to represent on the user profile;
program instructions, stored on the one or more computer readable storage media, to categorize the user information into groups;
program instructions, stored on the one or more computer readable storage media, to assign numerical values to lived experiences, wherein the lived experiences include educational experiences, personal experiences, cultural experiences, and skills and qualifications associated with one or more professions; and
program instructions, stored on the one or more computer readable storage media, to create a metric system of the lived experiences, based on role-playing game metrics.

11. The computer program product of claim 10, further comprising:
program instructions, stored on the one or more computer readable storage media, to identify the user information;
program instructions, stored on the one or more computer readable storage media, to map the user information with metadata associated with the user; and
program instructions, stored on the one or more computer readable storage media, to store the mapping of the user information with the metadata associated with the user.

12. The computer program product of claim 8, further comprising:
program instructions, stored on the one or more computer readable storage media, to create a dynamic digital human to serve as a digital representation of the user on one or more platforms, wherein the digital human is an avatar that produces human body language, backed by artificial intelligence that can interpret an input of the users and give facts back to the user and non-verbal responses.

13. The computer program product of claim 8, further comprising:
program instructions, stored on the one or more computer readable storage media, to create a dynamic user strategy guide, wherein the dynamic user strategy guide is a comprehensive manual that details and maps out one or more strategies to accomplish a goal or a task and automatically updates when additional user information is received.

14. The computer program product of claim 8, wherein the user information is received from a user through voice and converted to text for natural language processing purposes.

15. A computer system comprising:
one or more computer processors, one or more computer readable storage media, and program instructions stored on the one or more computer readable storage media for execution by at least one of the one or more computer processors, the program instructions comprising:
program instructions to receive user information to create a user profile, wherein the user information includes natural language input;
program instructions to create the user profile, wherein the user profile is based on the user information;
program instructions to generate a dynamic story using artificial intelligence, wherein the dynamic story is based on the user information; and
program instructions to display the dynamic story.

16. The computer system of claim 15, wherein the user information includes a picture, an answer to a question about a user, a resume, a professional experience, an educational experience, a lived experience, and a goal for the user.

17. The computer system of claim 15, further comprising:
program instructions, stored on the one or more computer readable storage media for execution by at least one of the one or more computer processors, to analyze the user information to determine how to represent on the user profile; and
program instructions, stored on the one or more computer readable storage media for execution by at least one of the one or more computer processors, to categorize the user information into groups.
program instructions, stored on the one or more computer readable storage media for execution by at least one of the one or more computer processors, to assign numerical values to lived experiences, wherein the lived experiences include educational experiences, personal experiences, cultural experiences, and skills and qualifications associated with one or more professions; and
program instructions, stored on the one or more computer readable storage media for execution by at least one of the one or more computer processors, to create a metric system of the lived experiences, based on role-playing game metrics.

18. The computer system of claim 17, further comprising:
program instructions, stored on the one or more computer readable storage media for execution by at least one of the one or more computer processors, to identify the user information;
program instructions, stored on the one or more computer readable storage media for execution by at least one of the one or more computer processors, to map the user information with metadata associated with the user; and
program instructions, stored on the one or more computer readable storage media for execution by at least one of the one or more computer processors, to store the mapping of the user information with the metadata associated with the user.

19. The computer system of claim 15, further comprising:
program instructions, stored on the one or more computer readable storage media for execution by at least one of the one or more computer processors, to create a dynamic digital human to serve as a digital representation of the user on one or more platforms, wherein the digital human is an avatar that produces human body language, backed by artificial intelligence that can interpret an input of the users and give facts back to the user and non-verbal responses.

20. The computer system of claim 15, further comprising:
program instructions, stored on the one or more computer readable storage media for execution by at least one of the one or more computer processors, to create a dynamic user strategy guide, wherein the dynamic user strategy guide is a comprehensive manual that details and maps out one or more strategies to accomplish a goal or a task and automatically updates when additional user information is received.
